(19) United States
(12) Patent Application Publication
(10) Pub. No.: US 2012/0296746 A1
(43) Pub. Date: Nov. 22, 2012

(54) TECHNIQUES TO AUTOMATICALLY SEARCH SELECTED CONTENT

(75) Inventors: George B. Bleadall, Boca Raton, FL (US); Shawn Stewart, Fort Lauderdale, FL (US); Ronnie Paskin, Fort Lauderdale, FL (US)

(73) Assignee: CBS INTERACTIVE INC., San Francisco, CA (US)

(21) Appl. No.: 13/112,849

(22) Filed: May 20, 2011

(51) Int. Cl. G06Q 30/00; G06F 3/048; G06F 17/30

(52) U.S. Cl. 705/14.66; 707/772; 715/823; 707/722; 707/723; 707/E17.108

(57) ABSTRACT

Techniques to automatically search selected content are described. In some embodiments, a method to automatically search selected content may include receiving a user selection of one or more objects in a document, automatically performing a search of local content on one or more servers associated with the document based on the one or more selected objects and displaying results from the search in a window within the document wherein the user selection comprises a highlighting of the one or more objects and the search is performed automatically in response to the highlighting. Other embodiments are described and claimed.

### BACKGROUND

Modern webpages and websites often include a broad array of media and content that is available for user consumption. The media and content is becoming increasingly dynamic, with some sites including content that is updated or changed on a frequent basis. Providing relevant, timely and accurate information about the content on a webpage or website is one important aspect of maintaining a dynamic website. When a user visits a website, it is advantageous to provide tools that enable the user to select content and receive further information about the content without leaving the site. It may be advantageous, for example, to provide additional information about certain content within a webpage or website upon a user request. As a result, it is desirable to enhance techniques for automatically searching for information about selected content. For example, it may be advantageous to create a tool that is operative to perform an automatic search based on a user selection of content. Consequently, there exists a substantial need for techniques to improve the automatic searching of selected content. It is with respect to these and other considerations that the present improvements have been needed.

### BRIEF DESCRIPTION OF THE DRAWINGS

FIG. 1A illustrates an embodiment of a system.

FIG. 1B illustrates an embodiments of a first logic flow

FIG. 2A illustrates an embodiment of a first user interface.

FIG. 2B illustrates an embodiment of a second user interface.

FIG. 2C illustrates an embodiments of a first heat map.

FIG. 3 illustrates an embodiment of a second logic flow.

FIG. 4 illustrates an embodiment of a computing architecture.

FIG. 5 illustrates an embodiment of a communications architecture.

### DETAILED DESCRIPTION

Various embodiments are directed to techniques to automatically search selected content. In some embodiments, for example, a computer-implemented method to automatically search selected content may comprise receiving a user selection of one or more objects in a document, automatically performing a search of local content on one or more servers associated with the document based on the one or more selected objects, and displaying results from the search in a window within the document. In some embodiments, the user selection comprises a highlighting of the one or more objects and the search is performed automatically in response to the highlighting. In various embodiments, a tool to perform the automatic searching of selected content may be described. The tool or method may provide a means to automatically search for information based on content on a website that is selected by a user.

In some embodiments, the tool may reside on one or more servers and may be operative to allow users to access additional or supplemental information that is not initially available on a webpage. In some embodiments, the additional information may include, but is not limited to, definitions, news stories, reviews, data files, image files, audio files, video files, reviews, .dat files, .html files or any other suitable data or files. Other embodiments are described and claimed. Additionally or alternatively, the tool may be implemented on a client computer implementing a web browser, such as a plug-in or add-on component for the web browser, for example.

Searching for information about selected content is not a new concept. Tools exist to allow users to view information about selected content on a particular website. One tool, for example, comprises an add-on or extension for a web browser that allows for the highlighting of text followed by a right click of a mouse button to enable or initiate a search. Other tools enable pop-ups or information boxes when a user places a mouse or other pointer in a certain location (e.g. over a double underlined word, for example). The information in these types of pop-ups is traditionally pre-loaded when the page is opened, which may require additional page loading time and may also be inconvenient if the user is uninterested in the information that is double underlined and repeatedly results in the pop-up appearing. These tools generally require pre-loading of the additional information or multiple steps on the part of the user to obtain the additional information, which decreased performance, user enjoyment and ease of use. These and other problems are addressed in the following techniques, methods, articles and apparatus. As a result, the described embodiments can improve the automatic searching of selected content.

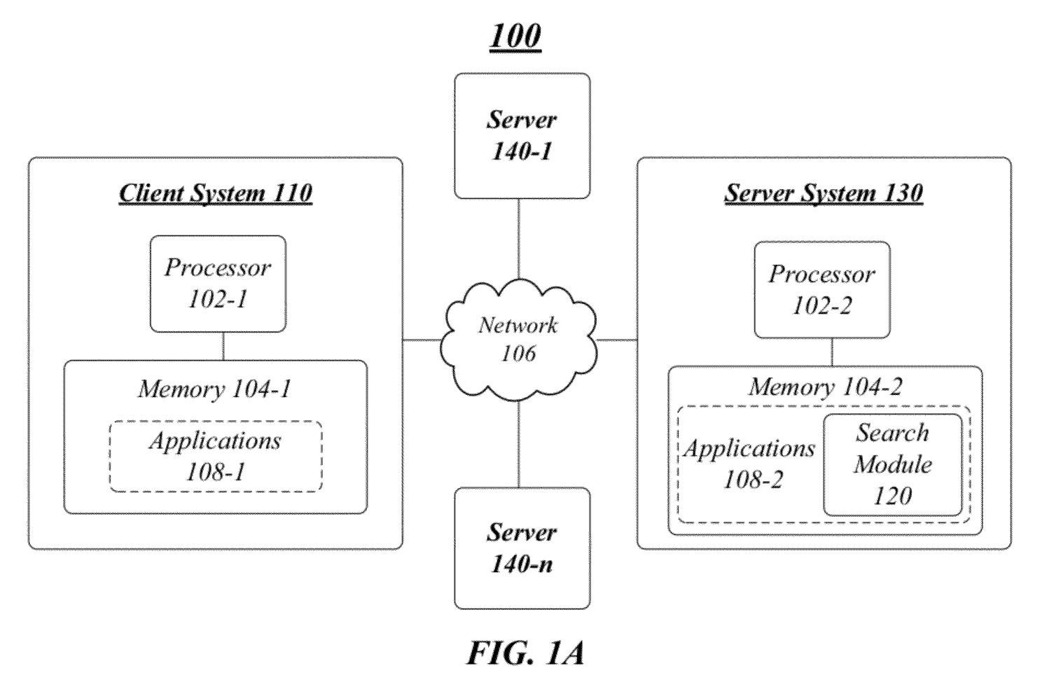

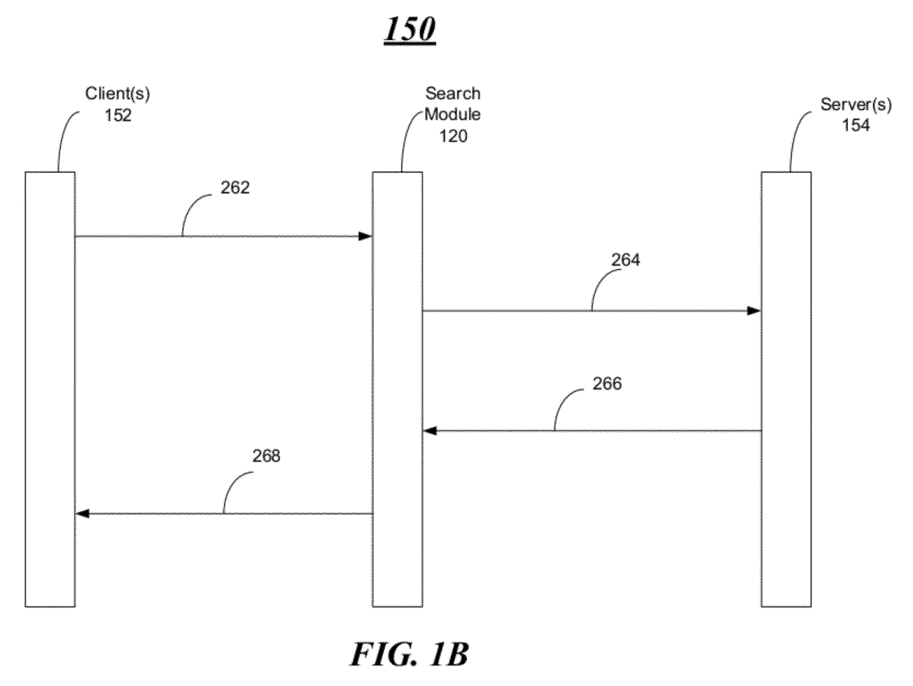

FIG. 1 illustrates a block diagram for a system 100 to automatically search based on selected content. In one embodiment, for example, the system 100 may comprise a computer-implemented system 100 having multiple components 110, 130 and 140-n. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The components 110, 130 and 140-n may be communicatively coupled via various types of communications media. The components 110, 130 and 140-n may coordinate operations between each other. The coordination may involve the uni-directional or bi-directional exchange of information. For instance, the components 110, 130 and 140-n may communicate information in the form of signals communicated over network 106. The information can be implemented as signals allocated to various signal lines or signals transmitted using any suitable signaling protocol. Other embodiments are described and claimed.

It is worthy to note that some embodiments may be described as comprising one or more elements. For instance, some elements may have labels containing variables such as “a” and “b” and “c” and “n” and similar designators. It is worthy to note that such designators are intended to be variables representing any positive integer. Thus, for example, if an implementation sets a value for n=5, then a complete set of components 140-n may include components 140-1, 140-2, 140-3, 140-4 and 140-5. The embodiments are not limited in this context.

System 100 may comprise a distributed system in some embodiments. The distributed system 100 may distribute portions of the structure and/or operations for the system across multiple computing entities. Examples of distributed system 100 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, for example, the distributed system 100 may be implemented as a client-server system. A client system 110 (or client 110) may be implemented as or comprise a user device, such as a personal computer, that may include one or more applications 108-1. A server system 130 (or server 130) may comprise a web server or other suitable device and may implement search module 120. Servers 140-n may comprise web servers arranged to provide or support web services for one or more webpages or websites. The client 110 and the servers 130 and 140-n may communicate with each over a network 106. In one embodiment, for example, the network 106 may comprise a wireless local area network (WLAN), a cellular radiotelephone network, or any other suitable computer network.

In various embodiments, the servers 130 and 140-n may comprise or employ one or more server computing devices and/or server programs that operate to perform various methodologies in accordance with the described embodiments. For example, when installed and/or deployed, a server program may support one or more server roles of the server computing device for providing certain services and features. Exemplary servers 130 and 140-n may include, for example, stand-alone and enterprise-class server computers operating a server OS such as a MICROSOFT® OS, a UNIX® OS, a LINUX® OS, or other suitable server-based OS. Exemplary server programs may include, for example, communications server programs for managing incoming and outgoing messages, messaging server programs for providing unified messaging (UM) for e-mail, voicemail, VoIP, instant messaging (IM), group IM, enhanced presence, and audio-video conferencing, and/or other types of programs, applications, or services in accordance with the described embodiments.

In various embodiments, client system 110 and server system 130 may respectively include, without limitation, processors 102-1 and 102-2, memory 104-1 and 104-2 and applications 108-1 and 108-2. While not shown in FIG. 1, servers 140-n may include the same or similar components to server system 130. In some embodiments, server system 130 may additionally include search module 120. Search module 120 may comprise one of applications 108-2 in some embodiments. In various embodiments, a component such as search module 120 may comprise hardware, software or any combination of hardware and software and still fall within the described embodiments. While search module 120 is shown as part of server system 130 in FIG. 1, it should be understood that search module 120 could be included anywhere in system 100 and still fall within the described embodiments. For example, search 120 could be implemented on client system 100 or in any of servers 140-n in some embodiments. Other embodiments are described and claimed.

Processors 108-1, 108-2 may comprise or include any type of processing unit, such as, for example, central processing unit (CPU), multi-core processor, multi-processing unit, a reduced instruction set computer (RISC), a processor that has a pipeline, a complex instruction set computer (CISC), digital signal processor (DSP), and so forth. In some embodiments, processors 102-1 and 102-2 may comprise or include logical and/or virtual processor cores. Each logical processor core may include one or more virtual processor cores in some embodiments. For example, each processor 102-1 and 102-2 may comprise a multi-core processor having two virtual cores resulting in a total of eight available cores for multi-core processors 102-1 and 102-2. The embodiments are not limited in this respect and other embodiments are described and claimed.

In various embodiments, memory 104-1 and 104-2 may comprise any suitable type of memory unit, memory device, memory article, memory medium, storage device, storage article, storage medium and/or storage unit, for example, memory, removable or non-removable media, volatile or non-volatile memory or media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like.

Applications 108-1 and 108-2 may comprise any application, logic, component, module or set of computer instructions suitable for execution by client system 110 or server system 130 in some embodiments. For example, applications 108-1 and 108-2 may include, without limitation, an operating system (OS), e-mail application, web browsing application, word processing application, media application, and so forth. While a limited number and type of applications are described for purposes of clarity, it should be understood that any suitable application could be used and still fall within the described embodiments.

In various embodiments, search module 120 may comprise one of applications 108-2. While search module 120 is shown as an application 108-2 contained in memory 104-2 for purposes of illustration, it should be understood that search module 120 could be located anywhere in system 100 and still fall within the described embodiments. For example, search module 120 need not be contained within memory 104-2. Search module 120 may provide or comprise an application or tool implementing various search engine techniques in some embodiments, including but not limited to indexing, crawling or any other suitable search engine technique. For example, search module 120, when executed by processor 102-2, may be operative to automatically search for information on servers 140-n based on a user selection of content received from client system 110. Other embodiments are described and claimed.

In various embodiments, the search module 120 may be programmed in accordance with various programming languages, application platforms and application frameworks, including JAVA made by Oracle Corporation, COLDFUSION made by Adobe Systems, .NET made by Microsoft® Corporation, WebORB for .NET, Hypertext Preprocessor (PHP), Ruby, Python, Perl, Lisp, Dylan, Pike, Cluster (CLU), Smalltalk, Eiffel, Ruby on Rails (RoR), C, C++, C#, and so forth. The logic 120 may also comprise part of a RIA, such as a front-end of a SOA for deployment on a web browser of a client computing device using various client side technologies, such as an Adobe Flash platform programmed in an object-oriented programming language such as ACTIONSCRIPT™ and ADOBE® FLEX, made by Adobe Systems Incorporated. It may be appreciated that these programming languages are provided by way of example and not limitation. Search module 120 may be implemented using any suitable programming language.

Search module 120 may be operative to automatically search for information based on a user selection of content in some embodiments. For example, search module 120 may be operative to receive a user selection of one or more objects in a document. In various embodiments, the user selection may be performed using some form of an input device (e.g., a keyboard, keypad, touchpad, mouse, pointing device, trackball, touch-screen, microphone, etc.) for highlighting or other selection of a word or other content in a webpage. For example, the highlighting may comprise a double click or tap on the one or more objects that results in the word being highlighted, an initiation click or tap to begin a selection and a release click or tap to complete the selection or highlighting or a multi-touch gesture operative to indicate a selection. One skilled in the art would understand that any suitable selection means or method could be used and still fall within the described embodiments.

In some embodiments, search module 120 may be operative to automatically perform a search of local content on one or more servers associated with the document based on the one or more selected objects. For example, the search may be performed automatically on one or more local servers in response to the highlighting in some embodiments. In various embodiments, a local server may comprise a server that is connected to, associated with or commonly controlled by a same entity that is responsible for the local content. This is different than previous solutions that require additional user interaction, such as a right-click to enable the search after selection or a pre-loading of information corresponding to a pre-selected set of key words or content and a search of non-local or remote servers. Automating the search based on the act of selecting the content or word in the document simplifies the search for the user, streamlines the search process and generally enhances the user experience by enabling quick access to information that may be of interest to the user. In one embodiment, the term “automatically” and “automating” and “automated” and its variations as used herein may generally refer to performing a task without user or manual intervention.

The search may be restricted to local content on one or more local servers in some embodiments, such as enterprise servers for a business entity, for example. For instance, the one or more servers may be operative to support one or more related websites including the webpage or document and the search engine may comprise a local search engine operative to search the one or more local servers. In various embodiments, for example, the search may be restricted to sites that are commonly owned or managed, such as a family of sites that are supported by one or more commonly owned or controlled servers. The sites may include the CBS® family of websites in some embodiments but the embodiments are not limited in this respect.

In some embodiments, a search engine for the search module 120 may be hosted on or supported by one or more of servers 140-n or server 130. By using a local search engine and restricting the search to local content, a site owner or manager may prevent or discourage users from leaving the site or family of sites when searching for additional information. For example, if the search engine used were a third party search engine such as a Google® search engine or Yahoo!® search engine, the search may produce results that lead the user away from the current site or any related sites. This may result in reduced revenue for the site owner or possibly may lead the user to inaccurate or unrelated information. In some embodiments, the local search engine may produce results from the automatic search that do not lead to non-related or commonly owned sites or documents. The embodiments are not limited in this context.

In various embodiments, search operations may be expanded to include a search of one or more selected servers, such as certain social media servers or other sources that do not comprise local content. For example, in addition to the local content retrieved from the search, the search engine or search module 120 may also be arranged to selectively search social media sites such as Facebook® or Twitter® to determine if any relevant social media information should be returned in the search. While a limited number and type of sites and servers are described for purposes of illustration, one skilled in the art would understand that the embodiments are not limited in this context.

Search module 120 may be operative to display the results from the search in a window within the document in some embodiments. In various embodiments the document may comprise a webpage and the window may comprise a defined region within the webpage or a new webpage that contains the search results. For example, when a user highlights content, a new window may automatically appear providing further information about the highlighted content based on the automatic search. The new window may comprise any suitable format or type of pop-up, and may include any number or type of information about the highlighted content. In some embodiments, the results of the search may be displayed in a window or defined region that is associated with or connected to the highlighted word. Other embodiments are described and claimed.

In various embodiments, search module 120, or any other suitable tool, application or module of system 100, may be operative to assign tags to the content on the one or more servers. For example, each of the servers in system 100 may include various types of multimedia content. This content may comprise or be associated with one or more websites, documents, articles stories or other media information. In various embodiments, the content may be organized or grouped according to tags that identify the content. For example, sports related content and media may include a sports tag, business related content and media may include a business tag, and sports business related content and media may include both a sports and a business tag. Any number and type of content, media and tag could be used and still fall within the described embodiments.

In some embodiments, the tags correspond to different types of media information and content and the search results may be sorted and displayed in the window based on the associated tags. For example, the window including the search results may be organized or arranged in such a way that the information retrieved from the search may be separated according to the tags associated with the information. In various embodiments, the window may include different headings for content having different tags. For example, the window may include a sports heading that includes sports content, a business heading that includes business content, a news heading including news content and any other suitable heading and content combination. In another example, each of the headings may have a defined format conveying a defined amount of information from each search result (e.g., a title, document name, first 2 sentences, an image, and so forth). In this manner a user may quickly ascertain contents of a search result to determine whether it is of interest to the user.

A heat map comprising a ranking of user-selected content may be generated and displayed in the document in some embodiments. For example, the heat map may comprise a grouping of information on the site or document that includes a grouping of content that the present user or other users have selected for further searching. In some embodiments, the search module 120 may be operative to order or size the content based on relevance, importance, frequency of search or any other suitable factor. In some embodiments, the heat map may include links to the search results for the selected content. For example, search module 120 may be operative to generate a list of related links based on the user selection or the heat map information and may display the list of related links in the document. The related links may be the same or different from the information contained in the heat map. In some embodiments, the related links may be more descriptive and may comprise links to other content or media.

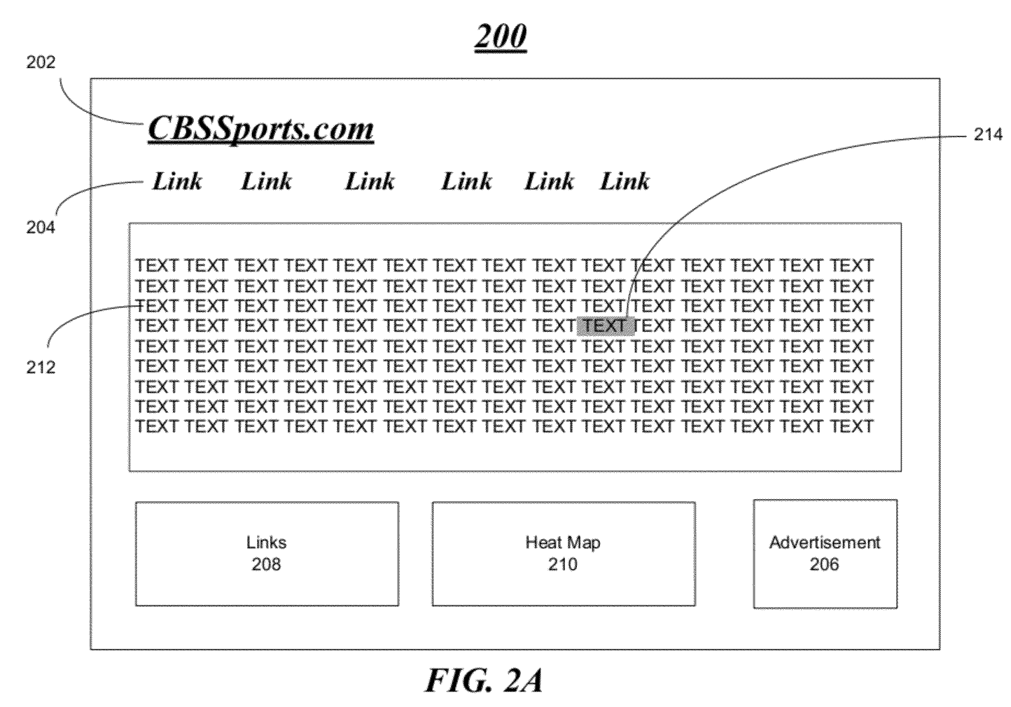

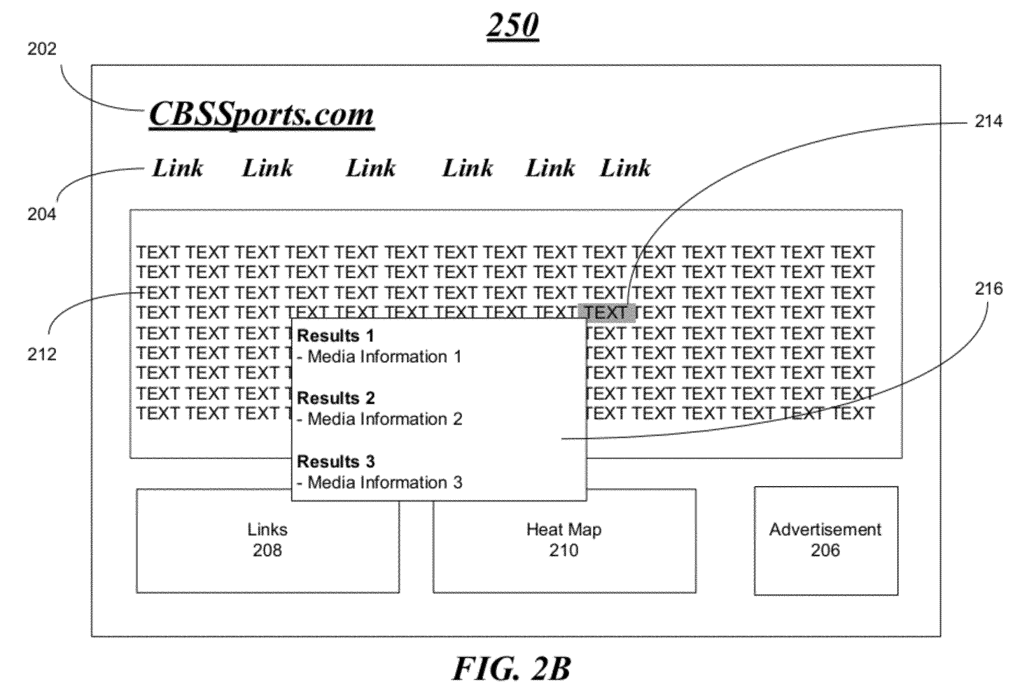

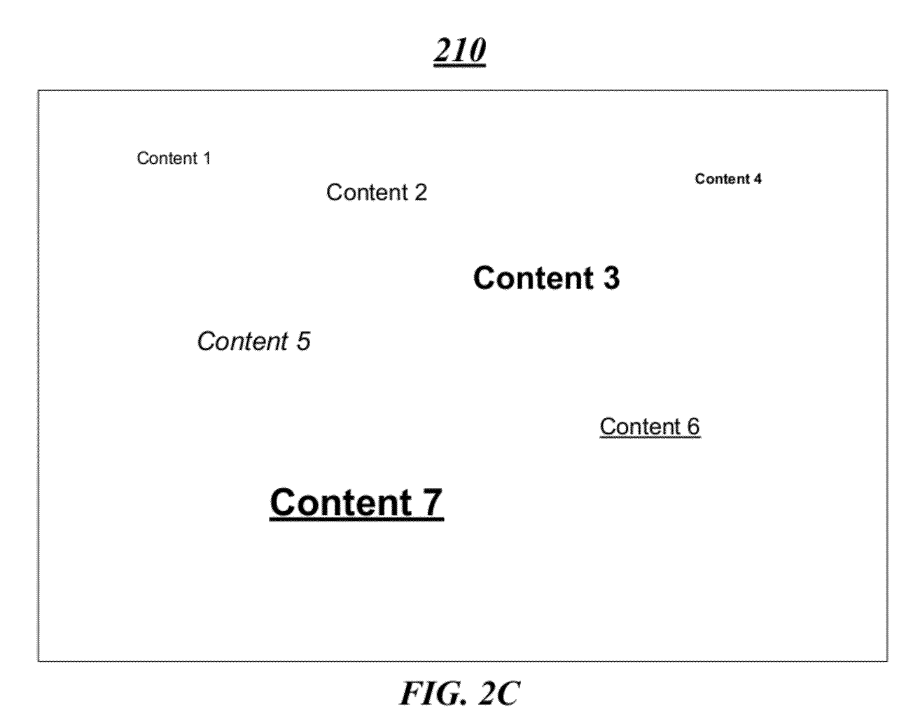

In some embodiments, a sample heat map 210 is illustrated in FIG. 2C. As shown in FIG. 2C, heat map 210 may graphically illustrate based on size, location, font type, font accent such as bold, underline or italics, or any other suitable parameter, content that is trending, is popular or is currently being searched on any of a number of websites. Each piece of identified content 1-7 in the heat map 210 may include a link to content related to a tag associated with the content in some embodiments. For example, content 7 may comprise a hyperlink that directs a web browser to other content such as articles, multimedia, advertisements or images related to content 7. The content in heat map 210 may be ordered, arranged, sized or highlighted based on any suitable ranking. For example, content 7 may be the most popular content in heat map 210, followed by content 3, content 5, content 6, content 2, content 1 and content 4 in a descending order of importance or popularity. The embodiments are not limited in this context. In some embodiments, the heat map may comprise a metric or logic that may be used for back end processing and may not be part of the user interface. Other embodiments are described and claimed.

In various embodiments, search module 120 may be operative to identify one or more users groups based on the one or more selected objects. For example, search module 120 may group any number of users together based on the content that the users select for further searching. In some embodiments, search module 120 may associate a user with one or more of the user groups based on their selections. Associating users with groups in this way allow for the customization of content, market research, or targeted advertising. For example, search module 120 may be operative to select one or more advertisements based on one or more characteristics of the one or more user groups and automatically display one or more advertisements in the document or site based on the grouping. Other embodiments are described and claimed.

Search module 120 may be operative to generate or assist in the generation of business intelligence information in some embodiments. For example, any number of the search requests or search results may be saved and used to gather information about what users are looking for, what information is important in different articles and content, and what information is important to different users and types of users. In various embodiments, content that is selected for searching may be correlated to each user or to what each user is viewing and this information may be used in the development of future content and media. In some embodiments, the business intelligence information may be used to automatically generate or display content that may be of particular interest to a user or group of users. Other embodiments are described and claimed.

FIG. 1B illustrates one embodiment of a message flow 150. As shown in FIG. 1B, message flow 150 includes search module 120, client(s) 152, server(s) 154 and information or actions 262, 264, 266 and 268. The embodiments are not limited to the number, type or arrangement of elements shown in FIG. 1B. In various embodiments, search module 220 may be the same or similar to search module 120 of FIG. 1A. Similarly, client(s) 152 and server(s) 154 may be the same or similar to client system 110 and server system 130 and/or servers 140-n respectively of FIG. 1A. The embodiments are not limited in this context.

In various embodiments, message flow 150 may be representative of the operations performed by search module 120 to perform an automatic search based on selected content. In some embodiments, search module 220 may receive a user selection 262 of one or more objects in a document from client(s) 152. For example, the user selection 262 may comprise a user or client 152 highlighting a word displayed on a webpage and viewed on a digital display of a mobile computing device. In response to the user selection 262, search module 120 may be operative to automatically send a search query 264 or perform a search of local content on server(s) 154 based on the user selection 262. For example, in some embodiments, the search query may comprise a search for content or information related to the highlighted word or user request 262 on one or more servers that are commonly owned or managed. The search query 264 may be constructed using a query language suitable for a given database, data schema or data structure implemented by the server(s) 154, such as a SQL query language, for example.

Search module 120 may be operative to receive search results 266 from server(s) 154 in some embodiments. For example, one or more of server(s) 154 may be configured as a search server and may be operative to search other associated or related server(s) 154 for information pertaining to the search query 264. In various embodiments, search module 120 may be operative to review, format and provide the search results 266 to client(s) 152 as formatted search results 268. Formatted search results 268 may comprise results that can be displayed to a user of client(s) 152. For example, the formatted results 268 may be grouped by tags associated with the content and may be presented in a manner that is compatible with a certain browser, operating system, type of device or other suitable parameter of client(s) 152. While a limited number and type of messages are described in FIG. 1B for purposes of illustration, it should be understood that any number of type of message or action could be used and still fall within the described embodiments.

FIG. 2A illustrates one embodiment of a user interface view 200. In various embodiments, user interface view 200 may comprise a visual representation of a website that is accessible by users of client system 100 of FIG. 1A, for example. In various embodiments, the website may comprise CBSSports.com, although the embodiments are not limited in this respect. As shown in FIG. 2A, user interface view 200 may include any number or arrangement of user interface elements, such as data, information, buttons, fields, toggles, radio buttons, links or any other information or interactive content suitable for use on a dynamic website.

In various embodiments, the user interface view 200 may include heading 202. Heading 202 may comprise a site identifier and may be operative to allow users to return to a pre-defined starting page by click on the heading 202. Links 204 and 208 may comprise any suitable hyperlink that points to or directs a user to another document, element or website. User interface view 200 may also include advertisement 206 in some embodiments. Advertisement 206 may include a link to or identifier associated with a product or service. The embodiments are not limited in this respect. Heat map 210 may comprise a grouping of key words that are related to information on the website or that have been searched for by other users.

User interface view 200 may include content 212 in some embodiments. Content 212 may comprise any text, visual media, audio media or other suitable content that is accessible for user consumption. For example, content 212 may comprise a journalistic article. As shown at 214, a user may select or highlight a portion of the content 214, which may activate or initiate an automatic search, which may perform operations similar to those described above with respect to search module 120 of FIG. 1A.

FIG. 2B illustrates one embodiment of a user interface view 250. In various embodiments, user interface view 250 may comprise the same or a similar user interface to that of FIG. 2A and like elements are similarly numbered. In some embodiments, user interface view 250 may comprise or include window 216 that may include results from the search that is automatically performed based on the user selection of content 214. For example, window 216 may include results 1, results 2 and results 3. Each result 1, 2 and 3 may comprise or include media information 1, 2, and 3 respectively that corresponds to the results 1, 2 and 3. In some embodiments, if the user were reading an article about a professional golfer and they selected content 214 that comprises the name of a golf course that they are not familiar with, the results in window 216 may relate to or include additional information about the golf course 214. For example, results 1 may include media information 1 that comprises other sports related articles or stories that mention the golf course 214, results 2 may include media information 2 that comprises a virtual tour of the golf course 214 that was previously included on a different site and results 3 may include media information 3 that includes a business article that discuss or mentions the golf course 214. Other embodiments are described and claimed. While a limited number, type and arrangement of information and elements are shown in FIGS. 2A and 2B for purposes of illustration, it should be understood that any suitable number, type or arrangement could be used and still fall within the described embodiments.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

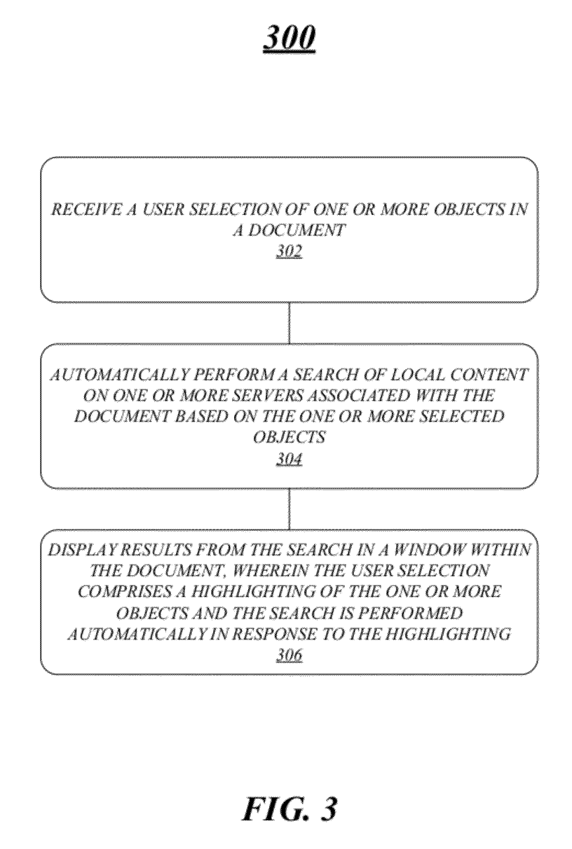

FIG. 3 illustrates one embodiment of a logic flow 300. The logic flow 300 may be representative of some or all of the operations executed by one or more embodiments described herein. For instance, the logic flow 300 may be implemented by the search module 120 of the system 100.

In the illustrated embodiment shown in FIG. 3, the logic flow 300 includes receiving a user selection of one or more objects in a document at block 302. For example, search module 120 of FIG. 1A may be operative to receive a request or selection of content from a user of client system 110, such as the highlighting of content in an article.

The logic flow 300 may automatically perform a search based on the one or more selected objects at block 304. For example, search module 120 may search one or more of servers 130 and 140-n for content or information related to the selected or highlighted content. In some embodiments, the search may be performed for local content on one or more servers associated with the documents. For example, the search may be limited to related servers or sites that are commonly owned or controlled.

The logic flow 300 may display results from the search in a window within the document at block 306. For example, as shown in FIG. 2B, window 216 may include search results related to the selected or highlighted content 214. In various embodiments, the search results window 216 may be displayed automatically based on the selection 214. For example, upon completion of the highlighting of content 214, the search may automatically be performed by search module 120 and the results 216 may be automatically displayed without any further user interaction. Other embodiments are described and claimed.

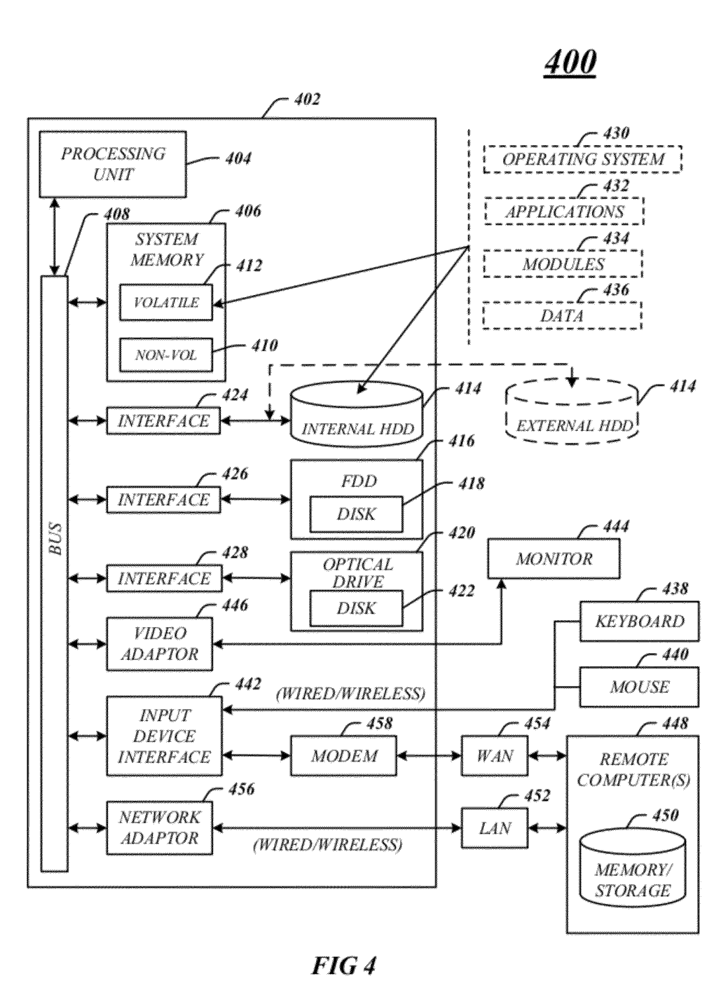

FIG. 4 illustrates an embodiment of an exemplary computing architecture 400 suitable for implementing various embodiments as previously described. The computing architecture 400 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 400.

As shown in FIG. 4, the computing architecture 400 comprises a processing unit 404, a system memory 406 and a system bus 408. The processing unit 404 can be any of various commercially available processors. Dual microprocessors and other multi-processor architectures may also be employed as the processing unit 404. The system bus 408 provides an interface for system components including, but not limited to, the system memory 406 to the processing unit 404. The system bus 408 can be any of several types of bus structure that may further interconnect to a memory bus (with or without a memory controller), a peripheral bus, and a local bus using any of a variety of commercially available bus architectures.

The system memory 406 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 4, the system memory 406 can include non-volatile memory 410 and/or volatile memory 412. A basic input/output system (BIOS) can be stored in the non-volatile memory 410.

The computer 402 may include various types of computer-readable storage media, including an internal hard disk drive (HDD) 414, a magnetic floppy disk drive (FDD) 416 to read from or write to a removable magnetic disk 418, and an optical disk drive 420 to read from or write to a removable optical disk 422 (e.g., a CD-ROM or DVD). The HDD 414, FDD 416 and optical disk drive 420 can be connected to the system bus 408 by a HDD interface 424, an FDD interface 426 and an optical drive interface 428, respectively. The HDD interface 424 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 410, 412, including an operating system 430, one or more application programs 432, other program modules 434, and program data 436. The one or more application programs 432, other program modules 434, and program data 436 can include, for example, the search module 120 of FIG. 1.

A user can enter commands and information into the computer 402 through one or more wire/wireless input devices, for example, a keyboard 438 and a pointing device, such as a mouse 440. Other input devices may include a microphone, an infra-red (IR) remote control, a joystick, a game pad, a stylus pen, touch screen, or the like. These and other input devices are often connected to the processing unit 404 through an input device interface 442 that is coupled to the system bus 408, but can be connected by other interfaces such as a parallel port, IEEE 1394 serial port, a game port, a USB port, an IR interface, and so forth.

A monitor 444 or other type of display device is also connected to the system bus 408 via an interface, such as a video adaptor 446. In addition to the monitor 444, a computer typically includes other peripheral output devices, such as speakers, printers, and so forth.

The computer 402 may operate in a networked environment using logical connections via wire and/or wireless communications to one or more remote computers, such as a remote computer 448. The remote computer 448 can be a workstation, a server computer, a router, a personal computer, portable computer, microprocessor-based entertainment appliance, a peer device or other common network node, and typically includes many or all of the elements described relative to the computer 402, although, for purposes of brevity, only a memory/storage device 450 is illustrated. The logical connections depicted include wire/wireless connectivity to a local area network (LAN) 452 and/or larger networks, for example, a wide area network (WAN) 454. Such LAN and WAN networking environments are commonplace in offices and companies, and facilitate enterprise-wide computer networks, such as intranets, all of which may connect to a global communications network, for example, the Internet.

When used in a LAN networking environment, the computer 402 is connected to the LAN 452 through a wire and/or wireless communication network interface or adaptor 456. The adaptor 456 can facilitate wire and/or wireless communications to the LAN 452, which may also include a wireless access point disposed thereon for communicating with the wireless functionality of the adaptor 456.

When used in a WAN networking environment, the computer 402 can include a modem 458, or is connected to a communications server on the WAN 454, or has other means for establishing communications over the WAN 454, such as by way of the Internet. The modem 458, which can be internal or external and a wire and/or wireless device, connects to the system bus 408 via the input device interface 442. In a networked environment, program modules depicted relative to the computer 402, or portions thereof, can be stored in the remote memory/storage device 450. It will be appreciated that the network connections shown are exemplary and other means of establishing a communications link between the computers can be used.

The computer 402 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

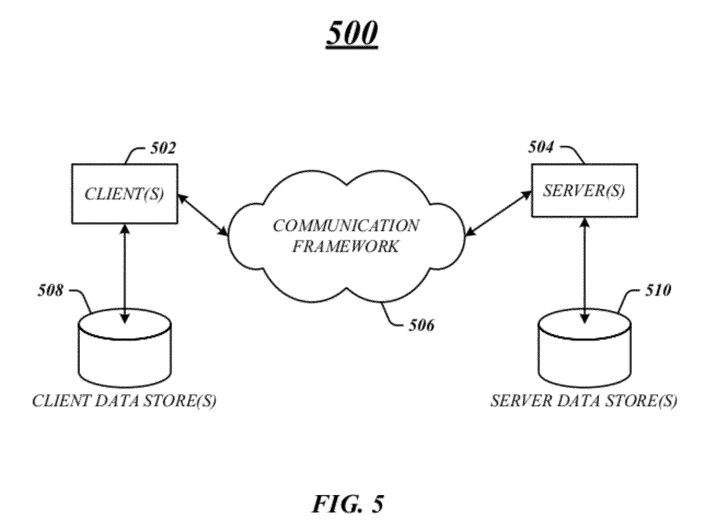

FIG. 5 illustrates a block diagram of an exemplary communications architecture 500 suitable for implementing various embodiments as previously described. The communications architecture 500 includes various common communications elements, such as a transmitter, receiver, transceiver, radio, network interface, baseband processor, antenna, amplifiers, filters, and so forth. The embodiments, however, are not limited to implementation by the communications architecture 500.

As shown in FIG. 5, the communications architecture 500 comprises one or more clients 502 and servers 504. The clients 502 may implement the client systems 110. The servers 504 may implement the server system 330 and 340-n. The clients 502 and the servers 504 are operatively connected to one or more respective client data stores 508 and server data stores 510 that can be employed to store information local to the respective clients 502 and servers 504, such as cookies and/or associated contextual information.

The clients 502 and the servers 504 may communicate information between each other using a communication framework 506. The communications framework 506 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 502 and the servers 504 may include various types of standard communication elements designed to be interoperable with the communications framework 506, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 502 and a server 504 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. In various embodiments, the storage medium may include a non-transitory storage medium. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a user selection of one or more objects in a document;
automatically performing a search of local content on one or more servers associated with the document based on the one or more selected objects in response to the user selection; and
displaying results from the search in a window within the document.

2. The computer-implemented method of claim 1, wherein the user selection comprises a highlighting of the one or more objects and wherein the search is performed automatically in response to the highlighting

3. The computer-implemented method of claim 1, wherein the document comprises a webpage and the window comprises a defined region within the webpage or a new webpage that contains the search results.

4. The computer-implemented method of claim 3, wherein the one or more servers are operative to support one or more related websites including the webpage.

5. The computer-implemented method of claim 4, wherein the search engine comprises a local search engine operative to search the one or more servers.

6. The computer-implemented method of claim 1, comprising:
assigning tags to the content on the one or more servers; and
sorting the search results displayed in the window based on the associated tags.

7. The computer-implemented method of claim 7, wherein the tags correspond to different types of media information.

8. The computer-implemented method of claim 1, comprising:
generating a heat map comprising a ranking of user selected content; and
displaying the heat map in the document.

9. The computer-implemented method of claim 1, comprising:
identifying one or more users groups based on the one or more selected objects;
associating a user with one or more of the user groups;
selecting one or more advertisements based on one or more characteristics of the one or more user groups; and
automatically displaying the one or more advertisements in the document.

10. The computer-implemented method of claim 1, comprising:
generating a list of related links based on the user selection; and
displaying the list of related links in the document.

11. The computer-implemented method of claim 1, wherein the highlighting comprises:
a double click or tap on the one or more objects;
an initiation click or tap to begin a selection and a release click or tap to complete the selection; or
a multi-touch gesture operative to indicate a selection.

12. An article comprising a computer-readable storage medium containing instructions that when executed by a processor enable a system to:
receive a user selection of one or more objects in a document;
automatically perform a search of local content on one or more servers associated with the document based on the one or more selected objects in response to the user selection; and
display results from the search in a window within the document.

13. The article of claim 12, wherein the user selection comprises a highlighting of the one or more objects and wherein the search is performed automatically in response to the highlighting.

14. The article of claim 12, wherein the document comprises a webpage and the window comprises a defined region within the webpage or a new webpage that contains the search results.

15. The article of claim 14, wherein the one or more servers are operative to support one or more related websites including the webpage.

16. The article of claim 15, wherein the search engine comprises a local search engine operative to search the one or more servers.

17. The article of claim 13, comprising instructions that when executed enable the system to:
assign tags corresponding to different types of media information to the content on the one or more servers; and
sort the search results displayed in the window based on the associated tags.

18. The article of claim 12, comprising instructions that when executed enable the system to:
generate a heat map comprising a ranking of user selected content;
display the heat map in the document;
generate a list of related links based on the user selection; and
display the list of related links in the document.

19. The article of claim 12, comprising instructions that when executed enable the system to:
identify one or more users groups based on the one or more selected objects;
associate a user with one or more of the user groups;
select one or more advertisements based on one or more characteristics of the one or more user groups; and
automatically display the one or more advertisements in the document.

20. The article of claim 12, wherein the highlighting comprises:
a double click or tap on the one or more objects;
an initiation click or tap to begin a selection and a release click or tap to complete the selection; or
a multi-touch gesture operative to indicate a selection.

21. An apparatus, comprising:
one or more processors; and
a memory communicatively coupled to the one or more processors, the memory to store a search module that when executed by the one or more processors is operative to receive a user selection of one or more objects in a document, automatically perform a search of local content on one or more servers associated with the document based on the one or more selected objects in response to the user selection, and display results from the search in a window within the document.

22. The apparatus of claim 21, wherein the user selection comprises a highlighting of the one or more objects and wherein the search is performed automatically in response to the highlighting.

23. The apparatus of claim 21, wherein the document comprises a webpage, the window comprises a defined region within the webpage or a new webpage that contains the search results, the one or more servers are operative to support one or more related websites including the webpage and the search engine comprises a local search engine operative to search the one or more servers.

24. The apparatus of claim 21, the search module operative to:
assign tags corresponding to different types of media information to the content on the one or more servers;
sort the search results displayed in the window based on the associated tags.
generate a heat map comprising a ranking of user selected content;
display the heat map in the document;
generate a list of related links based on the user selection; and
display the list of related links in the document.

25. The apparatus of claim 21, the search module operative to:
identify one or more users groups based on the one or more selected objects;
associate a user with one or more of the user groups;
select one or more advertisements based on one or more characteristics of the one or more user groups; and
automatically display the one or more advertisements in the document.

26. The apparatus of claim 21, wherein the highlighting comprises:
a double click or tap on the one or more objects;
an initiation click or tap to begin a selection and a release click or tap to complete the selection; or
a multi-touch gesture operative to indicate a selection.
